(19) United States
(12) Patent Application Publication
(10) Pub. No.: US 2020/0406581 A1
(43) Pub. Date: Dec. 31, 2020

(54) COMPOSITE LAMINATE RESIN AND FIBERGLASS STRUCTURE

(71) Applicant: TekModo OZ Holdings, LLC, Elkhart, IN (US)

(72) Inventor: Marc Douglas LaCounte, Goshen, IN (US)

(21) Appl. No.: 16/915,038

(22) Filed: Jun. 29, 2020

Related U.S. Application Data
(60) Provisional application No. 62/867,571, filed on Jun. 27, 2019.

(51) Int. Cl. B32B 5/26; B32B 5/02; B32B 3/12; B32B 5/18; B32B 5/24; B32B 5/06

(52) U.S. Cl. CPC B32B 5/26; B32B 2250/20; B32B 5/024; B32B 3/12; B32B 5/18; B32B 5/245; B32B 5/06; B32B 2262/101; B32B 2262/02; B32B 2307/54; B32B 2307/72; B32B 2307/514; B32B 2260/021; B32B 2262/106; B32B 2605/00; B32B 2419/00; B32B 2260/046; B32B 2262/14; B32B 2250/03; B32B 5/022

(57) ABSTRACT

A composite laminate structure comprising a core of non-woven thermoplastic/fiberglass mix matte, a top layer located on one side of said core, said top including uni-directional structural tape of woven glass/thermoplastic; and a bottom layer, on a side of said core opposite said top layer, said bottom layer including uni-directional structural tape of woven glass/thermoplastic, said top and bottom layers being heat-fused to said core.

This application claims priority from U.S. Provisional Patent Application Ser. No. 62/867,571 filed on Jun. 27, 2019, the complete disclosure of which are incorporated by reference as if fully rewritten herein.

### BACKGROUND OF THE INVENTION

The subject invention pertains to a composite laminate resin and fiberglass material and method of manufacturing the composite, and in particular, to a material and process for producing a lightweight, composite material that is particularly suitable for use in building construction, recreational vehicles and trucks and conversions thereof and/or for uses in various locations in an automobile or other transportation vehicle, include panel structures and/or an under-body shield.

In the commercial vehicle industry (including recreational vehicle industry, truck industry, and for conversion vehicles), it is common to use wall panels including fiberglass reinforcement for the exterior surface of a vehicle. The panels may have a variety of widths and commonly fall in an 8 foot to 10 foot range. It is also common to have established lengths for the panels, which include panels that may be as long as 40 feet or even more. Many of the presently used processes are cumbersome from a manufacturing process perspective including many movements of the panels to various stations, which increases the cost thereof. One example of making such panels is disclosed in U.S. Pat. No. 6,755,633 B2 to Miller, the entirety of which is incorporated herein by reference.

In one known and currently used processes, a composite material first begins with utilization of an elongated mold. The mold is somewhat larger in both the width and length, than the panels to be made to facilitate trimming of the panels. The mold surface of the panels is finished to provide a substantially flat and smooth surface, and the surface on the mold may be used to form the visible exterior surface of the panel.

In a known prior art method of manufacturing panels, a mold is first sprayed with a coating known as a gel coating, which cures to form a high gloss exterior surface for the panel. Once cured, a resin and fiberglass are applied to the top surface of the gel coating and then a plurality of panels, typically hard board, such as luan panels, are positioned side by side on top of the fiberglass. The seams between the panels are covered with a seam material and a vacuum bag is placed over the top of the panels and a slight vacuum is introduced which draws resin into luan panels to form a finished product. A completed product is then pulled off the mold and cut and trimmed to the proper size.

One method of applying the gel coating is to maintain the elongated mold in a stationary fashion then move the gel coating sprayer longitudinally along rails and spray the entire length of elongated mold. This can provide a sufficient gel coating on the mold, but due to the movement of the sprayer, capturing the fumes of the gel coating can be difficult. Furthermore, as maintenance of the mold is required, the molds are moved into and out of their various positions by way of an overhead crane, which due to the size of elongated mold, can be a difficult operation. An object of the invention is therefore to overcome the shortcomings of the prior art.

Another moldable fiber-reinforced product and method of producing it is disclosed in U.S. Pat. No. 8,540,830 B2 to Brentrup et al., the entirety of which is incorporated herein by reference. Bentrup et al. discloses a continuous method for producing a thermoplastically moldable semi-finished product of a thermoplastic material and reinforcing fibers. The method includes blending thermoplastic fibers and reinforcing fibers together to form a nonwoven blend, consolidating the nonwoven blend by needling or by a thermal treatment, heating the consolidated nonwoven blend to a temperature above the softening temperature of the thermoplastic, compressing the consolidated nonwoven blend successively in a heated compression mold and in a cooled compression mold at a pressure of less than 0.8 bar for at least 3 seconds, and optionally applying functional layers to the semi-finished product. The preferred product is a thermoplastically moldable semi-finished product of a thermoplastic material and reinforcing fibers with an average length of 20 to 60 mm and an air pore content of 35 to 65 vol. %.

It is an object of the present invention to provide an improved product and method of manufacture.

### SUMMARY OF THE INVENTION

In one embodiment of the invention, a composite laminate structure is provided that includes a core of non-woven thermoplastic/fiberglass mix matte, a top layer located on one side of the core, wherein the top layer has a uni-directional structural tape of woven glass/thermoplastic composites, and a bottom layer, located on a side of the core opposite the top layer. The bottom layer includes a uni-directional structural tape of woven glass/thermoplastic composites. The top and bottom layers are sealed to the core.

The top and bottom layers include continuous 0°-90° fiberglass reinforced thermoplastic. The core may include a needle punched matte, and the core includes a thermally treated matte. In one embodiment, the core has an area weight of 100 to 2500 g/m2 and a thickness from 0.5 to 6 mm. In another embodiment, the core has an area weight of 100 to 6,000 g/m2 and a thickness from 0.5 to 50 mm.

The top and bottom layers can be heat-fused to the non-woven thermoplastic/fiberglass mix matte, and the core can include thermoplastic and reinforcing fibers supplied in the form of multi-fiber strands. The multi-fiber strands can be carded so that, there are few unopened and partially opened strands and the matte has a homogenous appearance. The carded matte may have a lofty appearance prior to sealing it with the top and bottom layers.

In one embodiment, the top and bottom layers have uni-directional continuous composites oriented perpendicular to one another.

In another embodiment of the invention, a method of manufacturing a composite laminate structure includes the steps of providing a core of non-woven thermoplastic/fiberglass mix matte, providing a top layer wherein the top layer includes a continuous 0°-90° fiberglass reinforced thermoplastic; locating the top layer on one side of the core, and providing a bottom layer that includes continuous 0°-90° fiberglass reinforced thermoplastic. The bottom layer is located on a side of the core opposite the top layer, and the top and bottom layers are sealed to the core.

The top layer can include a uni-directional structural tape of woven glass/thermoplastic composites, and the bottom layer can also include uni-directional structural tape of woven glass/thermoplastic composites.

The method of manufacturing a composite laminate structure can also include the step of needle punching the core prior to sealing to the top and bottom layers.

The method of manufacturing a composite laminate structure may also include the step of thermally treating the matte prior to sealing it to the top and bottom layers. In one embodiment, the core has an area weight of 100 to 2500 g/m2 and a thickness from 0.5 to 6 mm. In another embodiment, the core has an area weight of 100 to 6,000 g/m2 and a thickness from 0.5 to 50 mm.

The method of manufacturing a composite laminate structure can also include the steps of heat fusing the top and bottom layers to the non-woven thermoplastic/fiberglass mix matte in a laminating machine, and supplying thermoplastic and reinforcing fibers in the form of multi-fiber strands, blending the multi-fiber strands in an air stream, and depositing the multi-fiber strands on a moving belt. The composite laminate structure may be run through and pressed with the laminate machine in multiple passes.

The method of manufacturing a composite laminate structure can also include the steps of carding multi-fiber strands to reduce unopened and partially opened strands and providing the matte in a homogenous appearance.

In one embodiment, the method of manufacturing a composite laminate structure includes the step of orienting the uni-directional fiberglass reinforced thermoplastic in the top and bottom layers perpendicular to one another.

The teachings herein are directed to a composite laminate structure comprising: a core of non-woven thermoplastic/fiberglass mix matte; a top layer located on one side of said core, said top including uni-directional structural tape of woven glass/thermoplastic; and a bottom layer, on a side of said core opposite said top layer, said bottom layer including uni-directional structural tape of woven glass/thermoplastic, said top and bottom layers being heat-fused to said core. The top and bottom layers may include continuous 0°-90° fiberglass reinforced thermoplastic.

The composite may have a thickness of from about 0.05 inches to about 1 inch. The laminate has a coefficient of thermal expansion of from about 3.0E-06 to about 10.0E-06 in as measured by ASTM D6341. The composite may have a strain at 1,000 psi of from about 0.05% to about 0.3%, or even from about 0.1% to about 0.2% as measured by ASTM D3039-08. The composite may have a strain at 2,500 psi of from about 0.1% to about 0.7%, or even from about 0.3% to about 0.5% as measured by ASTM D3039-08. The composite may have an ultimate strength of about 8,000 psi to about 20,000 psi, or even about 10,000 psi to about 17,000 psi as measured by ASTM D3039-08. The composite may have a density of about 30 lb/ft³ to about 50 lb/ft³, or even about 35 lb/ft³ to about 40 lb/ft³ as measured by ASTM D1622. The composite may have a burn rate of about 0.1 to about 1 inch/minute.

The thermoplastic material may be selected from polyethylene, polyamide, acrylic, polyester, polystyrene or polypropylene. The fibers may have a length of at least about 1 cm, 3 cm or even 5 cm. The fibers may have an average diameter of about 1 to about 50 microns, or even about 5 to about 25 microns.

The heat may be applied by a laminating process. The heat may be applied by a molding process. The composite may include a honeycomb, foam or pre-preg layer. The fibers may be oriented in a consistent repeated pattern in one or more layers of the composite. The fibers may be randomly distributed in one or more layers of the composite. The structure may be formed under time and pressure on a belt laminator.

The teachings herein are further directed to a composite laminate structure comprising: a core having a Continuous Fiber Reinforced Thermoplastic (CFRT) oriented in a very specific fiber direction; and top and bottom layers of non-carded, non-needle punched hybrid matte consisting of polypropylene/fiberglass reinforcement/thermoset binders.

The thermoplastic material may be selected from polyethylene, polyamide, acrylic, polyester, polystyrene, polypropylene, or any combination thereof. The thermoset material may be selected from polyurethane, epoxy, methacrylate, silicone, phenolic resin, polyester, or any combination thereof. The CFRT may include a plurality of fibers selected from glass fibers, carbon fibers, natural fibers or any combination thereof. The CFRT may include a plurality of fibers having a length of at least about 1 cm, 3 cm or even 5 cm. The CFRT may include a plurality of fibers having a length of at least about 1 cm, 3 cm or even 5 cm.

The teachings herein are further directed to use of the composite laminate structures described herein as a wall or floor structure in a commercial vehicle, as a material for building construction, or as a transportation vehicle panel.

### BRIEF DESCRIPTION OF THE DRAWINGS

The above-mentioned and other features and objects of this invention and the manner of obtaining them will become more apparent and the invention itself will be better understood by reference to the following description of embodiments of the present invention taken in conjunction with the accompanying drawings, wherein:

FIG. 1 is an exploded perspective view of a composite laminate resin and fiberglass structure in accordance with one embodiment of the subject invention;

FIG. 2 is a side view of the composite laminate resin and fiberglass structure of FIG. 1 and an assembled condition; and

FIG. 3 is a side view of another embodiment of the invention.

Corresponding reference characters indicate corresponding parts if there are more than one view. Although the drawing(s) represent an embodiment of the present invention, the drawing(s) are not necessarily to scale and certain features may be exaggerated in order to better illustrate and explain the present invention. The exemplification set out herein illustrates an embodiment of the invention, and such exemplifications are not to be construed as limiting the scope of the invention in any manner.

### DETAILED DESCRIPTION OF EMBODIMENTS OF THE INVENTION

The explanations and illustrations presented herein are intended to acquaint others skilled in the art with the invention, its principles, and its practical application. Accordingly, the specific embodiments of the present disclosure as set forth are not intended as being exhaustive or limiting. The scope of the invention should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

For the purposes of promoting an understanding of the principles of the invention, reference will now be made to the embodiments illustrated in the drawing(s), which are described below. It will nevertheless be understood that no limitation of the scope of the invention is thereby intended. The invention includes any alterations and further modifications in the illustrated devices and described methods and further applications of the principles of the invention, which would normally occur to one skilled in the art to which the invention relates.

The composite structures described herein may include one or more fiber components. The one or more fiber components may be non-woven or woven fibers. The fibers may form a scrim, a mat, a patch or some combination thereof. The fibers may be continuous fibers or discontinuous short fibers. The fibers may be polymeric fibers. The fibers may be glass fibers. The fibers may be carbon fibers. The fibers may be organic or inorganic fibers.

The fibers may be imbedded in a secondary material or resin. The secondary material may be a thermoplastic material. The secondary material may be a thermoset material. The secondary material may be a polymeric material. The secondary material may be a polyethylene-based material. The secondary material may be a polyamide-based material. The secondary material may include one or more of acrylics, polyesters, polystyrenes or polypropylene. The secondary material may include polyurethane, epoxy, methacrylate, rubber, silicone, phenolic resin or some combination thereof.

Each fiber may comprise a plurality of different materials. Each fiber may comprise a first material substantially surrounded by a second material. Each fiber may comprise a single material. One or more fibers of different materials may be combined to form a fiber layer of the composite. The fibers may be selected to act as reinforcing fibers. The fibers may be selected to melt at a specified temperature to act as a binder. The fibers may be selected to have adhesive capabilities when exposed to a stimulus (e.g., heat, UV light, or the like). The fiber layer may be described as a core layer.

The fibers may be utilized to form a skin layer (e.g., a top and/or bottom layer). The fibers may be integrated into a thermoplastic material. The fibers may be integrated into an adhesive material. The fibers may be integrated into a tape material. The fibers may be included a reinforced thermoplastic panel. Such reinforcing fibers may be continuous and extend along an entirety of the panel. Alternatively, the fibers may be located at only certain locations along a panel to provide selected reinforcement at such locations.

The fibers may be utilized as single strand filaments or may be multi-fiber strands. The fibers may be selected to all have similar lengths or may be selected to have differing lengths. It is possible that the fibers for forming one layer of the composite may be short discontinuous fibers whereas the fibers for forming a second layer of the composite may be long continuous fibers.

The fibers may have a length of at least about 1 cm, 3 cm or even 5 cm or longer. The fibers may have an average diameter of about 1 to about 50 microns (e.g., about 5 to about 25 microns). The fibers may have a suitable coating located thereon, which may increase the diameter of the fibers. The fibers may be present in one or more layers of the composite in an amount of at least about 10%, 20%, 30% or even 50% by weight. The fibers may be present in one or more layers of the composite in an amount below about 90%, 80%, or even below about 70%, by weight. By way of example, the fibers may be present in each layer, in an amount of about 20% to about 70% by weight. Fiber contents by weight may be determined in accordance with ASTM D2584-11.

The ratio of fibers (weight percent) to secondary material (in a single layer of the composite or in the entirety of the composite) may be from about 1:40 to about 40:1. The ratio of fibers to secondary material may be from about 1:20 to about 20:1. The ratio of fibers to secondary material may be from about 1:10 to about 10:1. The ratio of fibers to secondary material may be from about 1:2 to about 2:1. The ratio may be selected to maximize coverage of the fibers by the secondary material.

One or more layers of the composite structure may be formed from a honeycomb material, a pre-preg material, a foam material or combinations thereof. One or more layers may be formed of a plurality of fibers imbedded in a matrix material (which may be the secondary material). The matrix material may be a thermoplastic material. The matrix material may be a thermoset material.

One or more layers may remain in direct planar contact with an adjacent layer, but without the use of any adhesive or additional fastening means. Alternatively, one or more layers may include an adhesive material or a material that has adhesive qualities at certain predetermined temperatures. For example, the composite structure may be located into a mold or laminating device where it may experience increased temperatures that cause one or more materials within the composite to rise above their respective glass transition temperatures (Tg). This may cause adhesion between one or more layers of the composite material. It is also possible that the one or more layers include a metallic component so that an induction heating process may be utilized to raise the temperature of one or more components of the composite layers. It is also possible that one or more layers are formed from a tape material. Such tape material may include a single side or multiple sides having adhesive capability. The tape may be a pressure sensitive material that adheres upon exposure to a predetermined amount of pressure.

The composite may include only two layers. The composite may include only three layers. The composite may include only four layers. The composite may include only five layers.

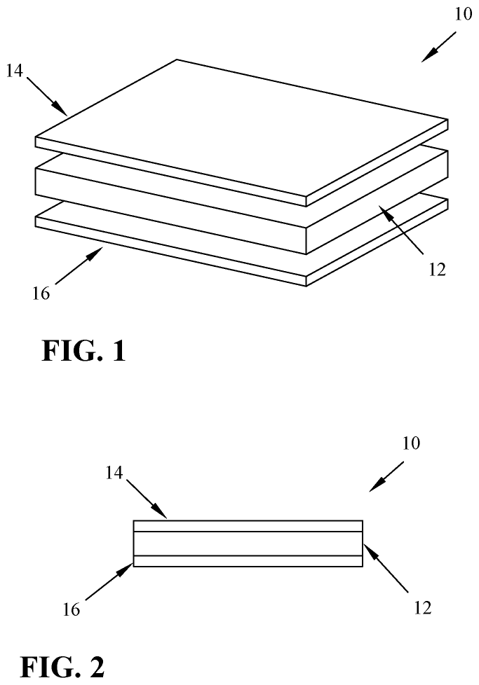

Now referring to FIGS. 1 and 2, a multi-layer fiberglass reinforced thermoplastic composite or structure, designed for lightweight composite panel applications, is disclosed and shown generally indicated in an exploded view as 10.

The core material consists of a needle punched and/or thermally treated, non-woven thermoplastic/fiberglass mix matte, generally indicated as 12. In one method of making such a thermoplastic/fiberglass mix matte, the thermoplastic and reinforcing fibers can be supplied in the form of multi-fiber strands, blended in an air stream, and deposited on a moving belt. The fibers, which at this stage can be in the form of strands, partially opened strands, and fibers, can be subjected to one or more carding operations. Following carding, the number of unopened and partially opened strands is low, so that the mat appears to be relatively homogenous. Following needling, a very homogenous appearance is achieved, with virtually no strands observable to the eye. The mat product is lofty. The fibers can be long or short as is known in the art. In one embodiment, the core material 12 has an area weight of 100 to 2500 g/m2 and a thickness from 0.5 to 6 mm. In another embodiment, the core has an area weight of 100 to 6,000 g/m2 and a thickness from 0.5 to 50 mm.

The core material 12 is sandwiched between top and bottom layers, generally indicated as 14, 16, respectively. In a preferred embodiment, good strength is achieved through the use of continuous 0°-90° fiberglass reinforced thermoplastic composite skins as top and bottom layers 14 and 16. In particular, uni-directional structural tape of woven glass/thermoplastic composites can be used for top and bottom layers.

In one method of manufacturing the multi-layer fiberglass reinforced thermoplastic composite or structure 10, the skins or top and bottom layers 14, 16 are heat-fused to lightweight fiberglass reinforced thermoplastic non-woven, needled-punched core 12. This creates an “I-Beam” type composite that is lightweight yet stiff. The structure can be fused in a laminating machine. It may take multiple passes to complete the laminating process.

The construct 10 displays excellent impact strength and flexural stiffness, while using a lightweight construct. The core density, resin to fiber reinforcement ratio, fiber placement, fiber size/type and core thickness can be tailored to meet desired mechanical properties. Furthermore, the skin density, resin to fiber reinforcement ratio, fiber placement/alignment, fiber size/type and skin thickness can be tailored to meet different mechanical properties.

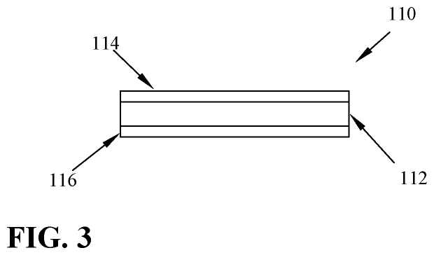

Now referring to FIG. 3, another embodiment of a novel construct is shown generally indicated as 110, whereby different layers of materials are combined in precise ways to then be put through a belt-laminator or heated by other means such as infrared, thereby creating a single composite construct that can then be used in many ways. This resultant construct can be heat molded to create specific shapes that are both lighter and tougher than tradition materials or can be used as a strength adding component layer in other constructs. The construct is novel in both the material used as well as the actual configuration of the layers. The uniqueness of the configuration is in the numbers/materials of layers used, the order in which the component layers are stacked up and the time/pressure the construct is in the belt-laminator, if such is used.

The primary layers in the construct 110 stack can include a non-carded, non-needle punched hybrid matte consisting of polypropylene/fiberglass reinforcement/thermoset binders, (which may be known as Material-X); a Continuous Fiber Reinforced Thermoplastic (CFRT) oriented in a very specific fiber direction; woven or knitted fiber mats made of fiberglass, carbon fiber, natural fibers, etc.; and/or other types of fibrous/PP mats with fibers of varying lengths oriented in a randomized fashion.

In particular, one example of a construct 110, which can be used as an automotive under-body shield among other things, includes a core layer of a Continuous Fiber Reinforced Thermoplastic (CFRT) which is shown generally indicated as 112 in FIG. 3. Core CFRT layer 112 is sandwiched between two layers of a non-carded, non-needle punched hybrid matte consisting of polypropylene/fiberglass reinforcement/thermoset binders (Material-X), which are generally indicated as a top layer 114 and a bottom layer 116.

The advantages and novelty of construct 110 include but are not limited to: Material-X top and bottom layers, 114 and 116, respectively provide finished surface layers and adds mass to the composite. Also, Material-X is a hybrid matte consisting of polypropylene/fiberglass reinforcement/thermoset binders. The polypropylene adds formability and ductility, the glass reinforcement adds stiffness, and the thermoset binder provides higher heat deflection, additional fiber wet-out, and stiffness. The Continuous Fiber Reinforced Thermoplastic (CFRT) adds structure, rigidity, and impact strength. These materials combined into layers create an ultra-high strength composite with excellent durability and low weight. This construct differs vastly from typical non-woven glass/polypropylene molded composites used throughout the industry today.

In other embodiments, the woven or knitted fiber mats made of fiberglass, carbon fiber, natural fibers, etc.; and/or other types of fibrous/PP mats with fibers of varying lengths oriented in a randomized fashion may be substituted for core layer 112 or either one or both added in as additional layers in the laminate.

To produce Material-X, it can be formed as a wet layered matt comprising a slurry with water that is formed on a chain with the fiberglass and polypropylene added in and then dried and rolled up. The construct may be heat activated in a belt laminator using temperatures, for example, in the 100 to 300° C. range or may be heated using infrared or other heating techniques. The pressure applied to the laminate can be very low or no pressure, such as when just heating by infrared to activate the thermoset binders, or pressures up to about 20 bars may be applied using a belt-laminator.

The overall approach of the subject invention varies vastly from typical constructs. The continuous glass combined with the non-woven and thermoset binders create a much more durable solution with lower overall panel weight than presently known panels.

The composite materials described herein also have additional physical properties that provide for improved performance, while also minimizing manufacturing challenges. Samples of various materials as described herein are subjected to a variety of tests for determining certain physical characteristics. The following tensile properties in Tables 1 and 2 below are measured in accordance with ASTM D3039-08. The densities as shown in Table 3 are measured in accordance with ASTM D1622. The linear coefficients of thermal expansion as shown in Tables 4 and 5 are measured in accordance with ASTM D6341-10.

TABLE 1

| | | | | | Chord | | | |
|---|---|---|---|---|---|---|---|---|
| | | | Strain at | Strain at | Modulus of | Ultimate | Ultimate | |
| Specimen | Width | Thickness | 1000 psi | 2500 psi | Elasticity | load | Strength | Failure |
| No. | (in) | (in) | (%) | (%) | (psi) | (lbf) | (psi) | mode |
| D1 | 1.021 | 0.192 | 0.15 | 0.37 | 6.74E+05 | 2240 | 11400 | L, M, V |
| D2 | 1.018 | 0.184 | 0.17 | 0.43 | 5.89E+05 | 2570 | 13700 | L, M, V |
| D3 | 1.019 | 0.184 | 0.15 | 0.37 | 6.85E+05 | 2410 | 12900 | L, M, V |
| D4 | 1.012 | 0.195 | 0.13 | 0.33 | 7.49E+05 | 2700 | 14400 | L, M, V |
| D5 | 1.011 | 0.185 | 0.13 | 0.33 | 7.59E+05 | 2870 | 15300 | G, A, T |
| Average | 1.016 | 0.186 | 0.15 | 0.36 | 6.91E+05 | 2558 | 13500 | |

TABLE 2

| | | | | | Chord | | | |
|---|---|---|---|---|---|---|---|---|
| | | | Strain at | Strain at | Modulus of | Ultimate | Ultimate | |
| Specimen | Width | Thickness | 1000 psi | 2500 psi | Elasticity | load | Strength | Failure |
| No. | (in) | (in) | (%) | (%) | (psi) | (lbf) | (psi) | mode |
| E1 | 1.003 | 0.198 | 0.13 | 0.34 | 7.48E+05 | 3230 | 16300 | L, M, V |
| E2 | 0.990 | 0.192 | 0.14 | 0.35 | 7.25E+05 | 3090 | 16300 | L, W, B |
| E3 | 1.003 | 0.197 | 0.14 | 0.34 | 7.25E+05 | 3150 | 15900 | L, W, B |
| E4 | 1.002 | 0.198 | 0.13 | 0.33 | 7.46E+05 | 3250 | 16400 | L, A, T |
| E5 | 1.003 | 0.186 | 0.15 | 0.37 | 6.76E+05 | 2680 | 14400 | L, A, B |
| Average | 1.000 | 0.194 | 0.14 | 0.35 | 7.24E+05 | 3080 | 15900 | |

Failure codes:
L—Lateral Failure Line;
S—Longitudinal Splitting Failure Line;
G—Gage Area;
A—At Grip/Tab;
M—Middle;
B—Bottom;
T—Top

TABLE 3

| Spec- | Thick- | | | | | Weight | |
|---|---|---|---|---|---|---|---|
| imen | ness | Width | Length | Mass | Volume | per ft² | Density |
| No. | (in) | (in) | (in) | (g) | (in³) | (lb/ft²) | (lb/ft³) |
| D1 | 0.187 | 5.986 | 5.987 | 67.380 | 6.70 | 0.5969 | 38.3 |
| D2 | 0.189 | 5.996 | 5.980 | 65.710 | 6.78 | 0.5818 | 36.94 |
| D3 | 0.191 | 5.995 | 5.990 | 66.340 | 6.86 | 0.5865 | 36.85 |
| E1 | 0.198 | 6.017 | 6.015 | 68.250 | 7.17 | 0.5987 | 36.28 |
| E2 | 0.198 | 6.018 | 6.012 | 69.810 | 7.16 | 0.6126 | 37.12 |
| E3 | 0.195 | 5.998 | 6.018 | 69.330 | 7.04 | 0.6098 | 37.52 |

TABLE 4

| Sample | Temp | Humidity | Length | Length | Length | Length | Length |
|---|---|---|---|---|---|---|---|
| Type | (° F.) | (%) | (in) D1 | (in) D2 | (in) D3 | (in) D4 | (in) D5 |
| D | −30 | N/A | 11.861 | 11.861 | 11.860 | 11.864 | 11.871 |
| D | 73 | 50 | 11.867 | 11.869 | 11.867 | 11.870 | 11.881 |
| D | 140 | 49 | 11.870 | 11.871 | 11.868 | 11.873 | 11.883 |
| α¹(in/in)/° F. | | | 4.35E−06 | 4.76E−06 | 4.44E−06 | 4.67E−06 | 6.48E−06 |

Average Coefficient of Thermal Expansion ((in/in)/° F.): 4.94E−06

TABLE 5

| Sample | Temp | Humidity | Length | Length | Length | Length | Length |
|---|---|---|---|---|---|---|---|
| Type | (° F.) | (%) | (in) E1 | (in) E2 | (in) E3 | (in) E4 | (in) E5 |
| E | −30 | N/A | 11.978 | 11.972 | 11.975 | 11.975 | 11.928 |
| E | 73 | 49 | 11.987 | 11.981 | 11.984 | 11.982 | 11.935 |
| E | 140 | 49 | 11.989 | 11.989 | 11.985 | 11.985 | 11.935 |
| α¹(in/in)/° F. | | | 5.56E−06 | 4.23E−06 | 4.98E−06 | 3.60E−06 | 3.77E−06 |

Average Coefficient of Thermal Expansion ((in/in)/° F.): 4.43E−06

TABLE 6

| | | | | | Coefficient | | Pass/Fail |
|---|---|---|---|---|---|---|---|
| | Ultimate | | | Density | of Thermal | | Burn test |
| | Strength | Modulus of | Weight | (lb/ft³) | Expansion | Burn | (pass = |
| | (psi) (ASTM | Elasticity | per ft² | (ASTM | (in/in)/° F. | Rate | less than |
| Sample | D3039-08) | (psi) | (lb/ft²) | D1622) | (ASTM D6341) | (in/min) | 4 in/min) |
| A (poly | 11.100 | 6.25E+05 | 0.5945 | 33.35 | 5.07E−06 | 0.78 | Pass |
| fiberglass) | | | | | | | |
| B (tape 1) | 14.600 | 7.31E+05 | 0.5844 | 37.04 | 3.41E−06 | 0.45 | Pass |
| C (tape 2) | 12.300 | 7.75E+05 | 0.5727 | 40.35 | 4.13E−06 | 0.96 | Pass |
| D (sample + | 13.500 | 6.91E+05 | 0.5884 | 37.36 | 4.94E−06 | 0.31 | Pass |
| tape 2) | | | | | | | |
| E (sample + | 15.900 | 7.24E+05 | 0.6070 | 36.98 | 4.43E−06 | 0.35 | Pass |
| tape 1) | | | | | | | |

Parts by weight as used herein refers to 100 parts by weight of the composition specifically referred to. Any numerical values recited in the above application include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

While the invention has been taught with specific reference to these embodiments, one skilled in the art will recognize that changes can be made in form and detail without departing from the spirit and scope of the invention. Therefore, the described embodiments are to be considered in all respects only as illustrative and not restrictive. As such, the scope of the invention is indicated by the following claims rather than by the description.

1. A composite laminate structure comprising:
a core of non-woven thermoplastic/fiberglass mix matte;
a top layer located on one side of said core, said top including uni-directional structural tape of woven glass/thermoplastic; and
a bottom layer, on a side of said core opposite said top layer, said bottom layer including uni-directional structural tape of woven glass/thermoplastic, said top and bottom layers being heat-fused to said core.

2. The composite laminate structure of claim 1, wherein said top and bottom exterior layers include continuous 0°-90° fiberglass reinforced thermoplastic.

3. The composite laminate structure of claim 1, wherein the composite has a thickness of from about 0.05 inches to about 1 inch.

4. The composite laminate structure of claim 1, wherein the composite has a coefficient of thermal expansion of from about 3.0E-06 to about 10.0E-06 in as measured by ASTM D6341.

5. The composite laminate structure of claim 1, wherein the composite has a strain at 1,000 psi of from about 0.05% to about 0.3%, or even from about 0.1% to about 0.2% as measured by ASTM D3039-08.

6. The composite laminate structure of claim 1, wherein the composite has a strain at 2,500 psi of from about 0.1% to about 0.7%, or even from about 0.3% to about 0.5% as measured by ASTM D3039-08.

7. The composite laminate structure of claim 1, wherein the composite has an ultimate strength of about 8,000 psi to about 20,000 psi, or even about 10,000 psi to about 17,000 psi as measured by ASTM D3039-08.

8. The composite laminate structure of claim 1, wherein the composite has a density of about 30 lb/ft³ to about 50 lb/ft³, or even about 35 lb/ft³ to about 40 lb/ft³ as measured by ASTM D1622.

9. The composite laminate structure of claim 1, wherein the composite has a burn rate of about 0.1 to about 1 inch/minute.

10. The composite laminate structure of claim 1, wherein the fibers have a length of at least about 1 cm, 3 cm or even 5 cm.

11. The composite laminate structure of claim 1, wherein the fibers have an average diameter of about 1 to about 50 microns, or even about 5 to about 25 microns.

12. The composite laminate structure of claim 1, wherein the core has an area weight of 100 to 2500 g/m2 and a thickness from 0.5 to 6 mm.

13. The composite laminate structure of claim 1, wherein the core has an area weight of 100 to 6000 g/m2 and a thickness from 0.5 to 50 mm.

14. The composite laminate structure of claim 1, wherein the composite includes a honeycomb, foam or pre-preg layer.

15. The composite laminate structure of claim 1, wherein the fibers are oriented in a consistent repeated pattern in one or more layers of the composite.

16. The composite laminate structure of claim 1, wherein the fibers are randomly distributed in one or more layers of the composite.

17. The composite laminate structure of claim 1, wherein the structure is formed under time and pressure on a belt laminator.

18. The composite laminate structure of claim 1, wherein the structure is formed under time and pressure on a belt laminator including multiple passes.

19. A composite laminate structure comprising:
a core having a Continuous Fiber Reinforced Thermoplastic (CFRT) oriented in a very specific fiber direction; and
top and bottom layers of non-carded, non-needle punched hybrid matte consisting of polypropylene/fiberglass reinforcement/thermoset binders.

20. The composite laminate structure of claim 19, wherein the thermoplastic material is selected from polyethylene, polyamide, acrylic, polyester, polystyrene, polypropylene, or any combination thereof.

21. The composite laminate structure of claim 19, wherein the thermoset material is selected from polyurethane, epoxy, methacrylate, silicone, phenolic resin, polyester, or any combination thereof.

22. The composite laminate structure of any of claim 19, wherein the CFRT includes a plurality of fibers selected from glass fibers, carbon fibers, natural fibers or any combination thereof.

23. The composite laminate structure of any of claim 19, wherein the CFRT includes a plurality of fibers having a length of at least about 1 cm, 3 cm or even 5 cm.

24. The composite laminate structure of any of claim 19, wherein the CFRT includes a plurality of fibers having a length of at least about 1 cm, 3 cm or even 5 cm.

25. Use of the composite laminate structure of claim 1 as a wall or floor structure in a commercial vehicle.

26. Use of the composite laminate structure of claim 1 as a material for building construction.

27. Use of the composite laminate structure of claim 1 as a transportation vehicle panel.
